(19) United States
(12) Patent Application Publication
(10) Pub. No.: US 2026/0329254 A1
(43) Pub. Date: Oct. 22, 2026

(54) DEFORMATION OF THREE-DIMENSIONAL PRINTED SURFACES USING SNAKE ROBOTS

(71) Applicant: International Business Machines Corporation, Armonk, NY (US)

(72) Inventors: Jonathan COTTRELL, Canandaigua, NY (US); Tushar AGRAWAL, West Fargo, ND (US); Sarbajit Kumar RAKSHIT, Kolkata (IN); Carolina GARCIA DELGADO, Zapopan (MX)

(21) Appl. No.: 19/181,037

(22) Filed: Apr. 16, 2025

(51) Int. Cl. G05B 19/4099; B29C 64/386; B33Y 50/00

(52) U.S. Cl. CPC G05B 19/4099; B29C 64/386; B33Y 50/00; G05B 2219/35134; G05B 2219/49023

(57) ABSTRACT

In some implementations, a computer may simulate deformation of a three-dimensional (3D) printed object, wherein the simulating is performed using one or more digital models of the 3D printed object. The computer may identify, based at least in part on the simulating, a first portion of the 3D printed object that will remain static and a second portion of the 3D printed object that will deform. The computer may analyze specifications of a plurality of snake robots on which the 3D printed object will be created. The computer may determine a structural arrangement of the plurality of snake robots to enable the plurality of snake robots to deform the second portion of the 3D printed object, wherein the structural arrangement comprises a quantity of the plurality of snake robots and positioning of the plurality of snake robots with respect to each other.

### BACKGROUND

This disclosure relates to computing systems, and more specifically, to the design and management of three-dimensional (3D) printing operations which use snake robots to deform 3D printed surfaces.

### SUMMARY

Some aspects described herein relate to a method. The method may include simulating deformation of a 3D printed object. The method may include identifying, based at least in part on the simulating, a first portion of the 3D printed object that will remain static and a second portion of the 3D printed object that will deform. The method may include analyzing specifications of a plurality of snake robots on which the 3D printed object will be created. The method may include determining a structural arrangement of the plurality of snake robots to enable the plurality of snake robots to deform the second portion of the 3D printed object.

Some aspects described herein relate to a computer system. The computer system may include a processor set, one or more computer-readable storage media, and program instructions stored on the one or more computer-readable storage media to cause the processor set to perform operations. The operations may include generating a digital model of an object in an environment. The operations may include using the digital model to generate a simulation identifying deformation of one or more portions of the object over one or more locations in the environment, and one or more forces on the object to cause the deformation. The operations may include determining, based at least in part on the simulation, the arrangement of the plurality of snake robots to supply the one or more forces to cause the deformation.

Some aspects described herein relate to a computer product. The computer product may include a processor set, one or more computer-readable storage media, and program instructions stored on the one or more computer-readable storage media to cause the processor set to perform operations. The operations may include generating a digital twin model of a deformable 3D printed object. The operations may include iteratively running a plurality of simulations of deformation of the deformable 3D printed object using the digital twin model. The operations may include designing, based on the plurality of simulations, a mesh-like structure of a plurality of robots over which the deformable 3D printed object is to be printed.

### BRIEF DESCRIPTION OF THE DRAWINGS

FIG. 1 is a diagram of an example computing environment for the design and management of 3D printing operations that utilize snake robots to deform 3D printed objects described herein.

FIG. 2 is a diagram of an example implementation associated with a 3D printing environment.

FIGS. 3A and 3B illustrate example implementations of a plurality of snake robots.

FIGS. 4A and 4B illustrate example implementations of a 3D printed object in a non-deformed state and a deformed state.

FIGS. 5A and 5B illustrate example implementations of a 3D printed object with a portion of the 3D printed object in a non-deformed state and a portion of the 3D printed object in a deformed state.

FIG. 6 is a flowchart of an example process associated with the design and management of 3D printing operations.

FIG. 7 is a flowchart of an example process associated with the design and management of 3D printing operations.

FIG. 8 is a flowchart of an example process associated with the design and management of 3D printing operations.

### DETAILED DESCRIPTION

The following detailed description of example implementations refers to the accompanying drawings. The same reference numbers in different drawings may identify the same or similar elements.

3D printing technology has advanced significantly in recent years, enabling the creation of complex shapes and structures. However, a limitation of traditional 3D printing is that it can be difficult to achieve specific surface deformations or shapes, which can be necessary for various industrial applications.

Traditional 3D printing techniques may struggle to produce printed objects with specific surface deformations, as such techniques often rely on layer-by-layer deposition methods that can be limited in their ability to create complex shapes. Additionally, a 3D printed object may need to be deformed while the object is being applied over a particular area, which may require manual intervention. In some instances, manual intervention may not be possible when the area over which the 3D printed object is being formed is difficult or impossible to reach and/or in an environment with harsh conditions. This can result in portions that are not adequately covered, leading to reduced performance, equipment breakdown and/or malfunctions, dangerous conditions, and/or inefficient operation.

Some implementations described herein provide a method for adaptive 3D-printed surface deformation using a robotic structural arrangement. For example, the method may include simulating deformation of a 3D printed object, and identifying a first portion of the 3D printed object that will remain static and a second portion of the 3D printed object that will deform. The method may further include analyzing specifications of a plurality of snake robots on which the 3D printed object will be created, and determining a structural arrangement of the plurality of snake robots to enable the plurality of snake robots the plurality of snake robots to deform the second portion of the 3D printed object.

In this way, the method provides a solution to the problem of creating customized 3D printed parts with specific surface deformations. The snake robots, which may be in a mesh-like structural arrangement, may operate collectively to provide physical strength and generate required forces for deformation of a 3D printed object. Additionally, the method provides for reduced material usage by optimizing material allocation for the static and deformable portions of the 3D printed object. Furthermore, the method results in reduced computational complexity since deformation is simulated and structural arrangements are determined in advance, which minimizes the need for trial-and-error approaches and thereby conserves processing resources, memory resources, and network resources.

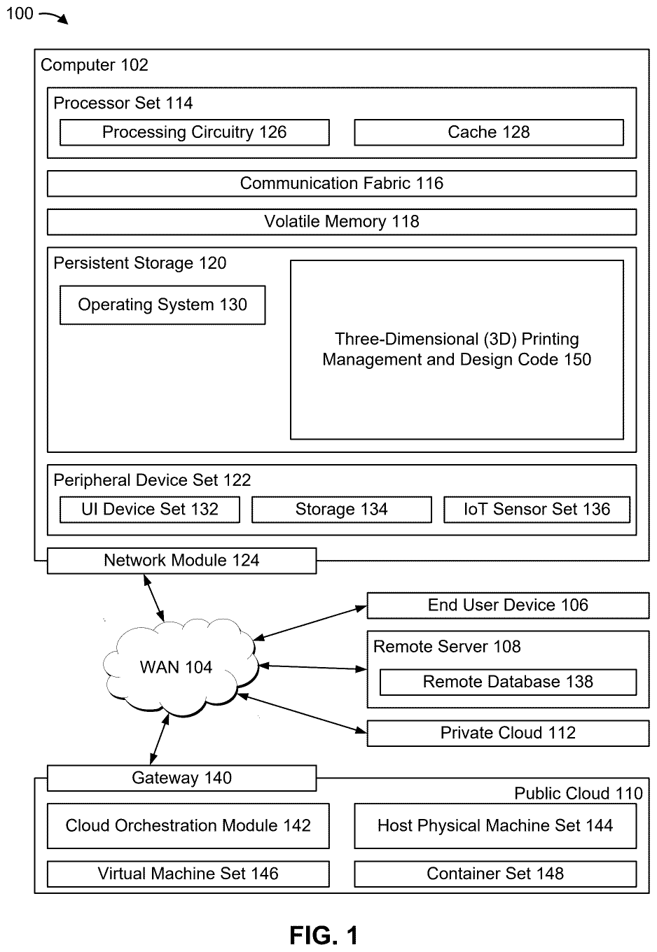

FIG. 1 is a diagram of an example computing environment 100 for the design and management of 3D printing operations that utilize snake robots to deform 3D printed objects described herein.

The computing environment 100 contains an example of an environment for the execution of at least some of the computer code involved in performing the inventive methods, such as 3D printing management and design code 150. In addition to the 3D printing management and design code 150, the computing environment 100 includes, for example, a computer 102, a wide area network (WAN) 104, an end user device (EUD) 106, a remote server 108, a public cloud 110, and a private cloud 112. In this embodiment, the computer 102 includes a processor set 114 (including processing circuitry 126 and a cache 128), communication fabric 116, volatile memory 118, persistent storage 120 (including an operating system 130 and the 3D printing management and design code 150, as identified above), a peripheral device set 122 (including a user interface (UI) device set 132, storage 134, and an Internet of Things (IoT) sensor set 136), and a network module 124. The remote server 108 includes a remote database 138. The public cloud 110 includes a gateway 140, a cloud orchestration module 142, a host physical machine set 144, a virtual machine set 146, and a container set 148.

The computer 102 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as the remote database 138. As is well understood in the art of computer technology, and depending upon the technology, performance of a computer-implemented method may be distributed among multiple computers and/or between multiple locations. On the other hand, in this presentation of the computing environment 100, detailed discussion is focused on a single computer, specifically the computer 102, to keep the presentation as simple as possible. The computer 102 may be located in a cloud, even though it is not shown in a cloud in FIG. 1. On the other hand, the computer 102 is not required to be in a cloud except to any extent as may be affirmatively indicated.

Computer-readable program instructions are typically loaded onto the computer 102 to cause a series of operational steps to be performed by the processor set 114 of the computer 102 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as the cache 128 and the other storage media discussed below. The program instructions, and associated data, are accessed by the processor set 114 to control and direct performance of the inventive methods. In the computing environment 100, at least some of the instructions for performing the inventive methods may be stored in 3D printing management and design code 150 in the persistent storage 120.

The communication fabric 116 is the signal conduction path that allows the various components of the computer 102 to communicate with each other. Typically, this fabric is made of switches and electrically conductive paths, such as the switches and electrically conductive paths that make up buses, bridges, and/or physical input/output ports, among other examples. Other types of signal communication paths may be used, such as fiber optic communication paths and/or wireless communication paths, among other examples.

The volatile memory 118 is any type of volatile memory now known or to be developed in the future. Examples include dynamic type random access memory (RAM) or static type RAM. Typically, the volatile memory 118 is characterized by random access, but this is not required unless affirmatively indicated. In the computer 102, the volatile memory 118 is located in a single package and is internal to the computer 102, but, alternatively or additionally, the volatile memory 118 may be distributed over multiple packages and/or located externally with respect to the computer 102.

The code included in the 3D printing management and design code 150 typically includes at least some of the computer code involved in performing one or more operations described herein. In some implementations, the operations may include simulating deformation of a 3D printed object, wherein the simulating is performed using one or more digital models of the 3D printed object; identifying, based at least in part on the simulating, a first portion of the 3D printed object that will remain static and a second portion of the 3D printed object that will deform; analyzing specifications of a plurality of snake robots on which the 3D printed object will be created, and determining a structural arrangement of the plurality of snake robots to enable the plurality of snake robots to deform the second portion of the 3D printed object, wherein the structural arrangement comprises a quantity of the plurality of snake robots and positioning of the plurality of snake robots with respect to each other.

In some implementations, the operations may include generating a digital model of an object in an environment, wherein the object is to be printed by a 3D printing device, and wherein the object is to be printed on an arrangement of a plurality of snake robots; using the digital model to generate a simulation identifying deformation of one or more portions of the object over one or more locations in the environment, and one or more forces on the object to cause the deformation; and determining, based at least in part on the simulation, the arrangement of the plurality of snake robots to supply the one or more forces to cause the deformation, wherein the arrangement comprises the plurality of snake robots in an orientation with respect to each other.

In some implementations, the operations may include generating a digital twin model of a deformable 3D printed object; iteratively running a plurality of simulations of deformation of the deformable 3D printed object using the digital twin model; and designing, based on the plurality of simulations, a mesh-like structure of a plurality of robots over which the deformable 3D printed object is to be printed, wherein the plurality of simulations compute one or more loads on the deformable 3D printed object to cause the deformation, and wherein designing the mesh-like structure comprises defining a shape and dimensions of the mesh-like structure to exert the one or more loads on the deformable 3D printed object.

The peripheral device set 122 includes the set of peripheral devices of the computer 102. Data communication connections between the peripheral devices and the other components of the computer 102 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, the UI device set 132 may include components such as a display screen, speaker, microphone, wearable devices (such as goggles and smart watches), keyboard, mouse, printer, touchpad, game controllers, and haptic devices. The storage 134 is external storage, such as an external hard drive, or insertable storage, such as an SD card. The storage 134 may be persistent and/or volatile. In some embodiments, the storage 134 may take the form of a quantum computing storage device for storing data in the form of qubits. In embodiments where the computer 102 is required to have a large amount of storage (for example, where the computer 102 locally stores and manages a large database), then this storage may be provided by peripheral storage devices designed for storing very large amounts of data, such as a storage area network (SAN) that is shared by multiple, geographically distributed computers. The IoT sensor set 136 is made up of sensors that can be used in Internet of Things applications. For example, one sensor may be a thermometer and another sensor may be a motion detector.

The network module 124 is the collection of computer software, hardware, and firmware that allows the computer 102 to communicate with other computers through the WAN 104. The network module 124 may include hardware, such as modems or Wi-Fi signal transceivers, software for packetizing and/or de-packetizing data for communication network transmission, and/or web browser software for communicating data over the internet. In some embodiments, network control functions and network forwarding functions of the network module 124 are performed on the same physical hardware device. In other embodiments (for example, embodiments that utilize software-defined networking (SDN)), the control functions and the forwarding functions of the network module 124 are performed on physically separate devices, such that the control functions manage several different network hardware devices. Computer-readable program instructions for performing the inventive methods can typically be downloaded to the computer 102 from an external computer or external storage device through a network adapter card or network interface included in the network module 124.

The WAN 104 is any wide area network (for example, the internet) capable of communicating computer data over non-local distances by any technology for communicating computer data, now known or to be developed in the future. In some embodiments, the WAN 104 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers, and/or edge servers, among other examples.

The EUD 106 is any computer system that is used and controlled by an end user (for example, a customer of an enterprise that operates the computer 102), and may take any of the forms discussed above in connection with the computer 102. The EUD 106 typically receives helpful and useful data from the operations of the computer 102. For example, in a hypothetical case where the computer 102 is designed to provide a recommendation to an end user, this recommendation would typically be communicated from the network module 124 of the computer 102 through the WAN 104 to the EUD 106. In this way, the EUD 106 can display, or otherwise present, the recommendation to an end user. In some embodiments, the EUD 106 may be a client device, such as thin client, heavy client, mainframe computer, and/or desktop computer, among other examples.

The remote server 108 is any computer system that serves at least some data and/or functionality to the computer 102. The remote server 108 may be controlled and used by the same entity that operates the computer 102. The remote server 108 represents the machine(s) that collect and store helpful and useful data for use by other computers, such as the computer 102. For example, in a hypothetical case where the computer 102 is designed and programmed to provide a recommendation based on historical data, then this historical data may be provided to the computer 102 from the remote database 138 of the remote server 108.

The public cloud 110 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of the public cloud 110 is performed by the computer hardware and/or software of the cloud orchestration module 142. The computing resources provided by the public cloud 110 are typically implemented by virtual computing environments that run on various computers making up the computers of the host physical machine set 144, which is the universe of physical computers in and/or available to the public cloud 110. The virtual computing environments (VCEs) typically take the form of virtual machines from the virtual machine set 146 and/or containers from the container set 148. It is understood that these VCEs may be stored as images and may be transferred among and between the various physical machine hosts, either as images or after instantiation of the VCE. The cloud orchestration module 142 manages the transfer and storage of images, deploys new instantiations of VCEs and manages active instantiations of VCE deployments. The gateway 140 is the collection of computer software, hardware, and firmware that allows the public cloud 110 to communicate through the WAN 104.

Some further explanation of VCEs will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

The private cloud 112 is similar to the public cloud 110, except that the computing resources are only available for use by a single enterprise. While the private cloud 112 is depicted as being in communication with the WAN 104, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, the public cloud 110 and the private cloud 112 are both part of a larger hybrid cloud.

Cloud computing services and/or microservices (not separately shown in FIG. 1): private cloud 112 and public clouds 110 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of application programming interfaces (APIs). One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

FIG. 1 is provided as an example. Other examples may differ from what is described with regard to FIG. 1.

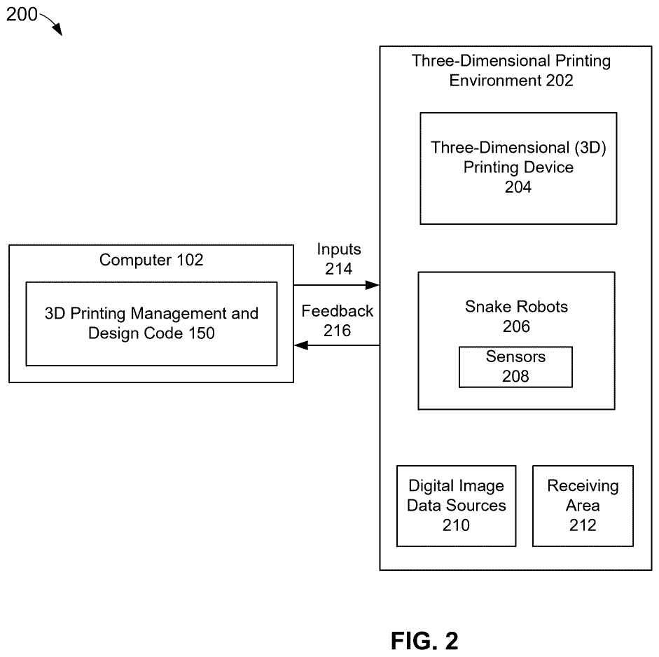

FIG. 2 is a diagram of an example implementation 200 associated with a 3D printing environment 202. As shown in FIG. 2, example implementation 200 includes a computer 102 which utilizes the 3D printing management and design code 150. The 3D printing environment 202 includes a 3D printing device 204, a structural arrangement of snake robots 206, where the snake robots 206 include one or more sensors 208, one or more digital image data sources 210, and a receiving area 212 to which a 3D printed object is applied. The 3D printed object may be deformed over certain portions of the receiving area 212. In some cases, the 3D printed object may be 3D printed onto the receiving area 212. Additionally and/or alternatively, the 3D printed object is 3D printed before being applied to the receiving area 212.

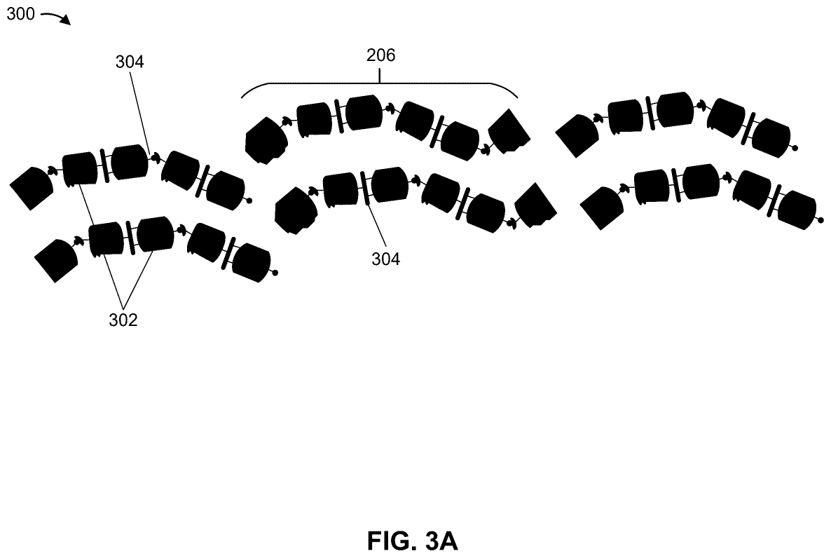

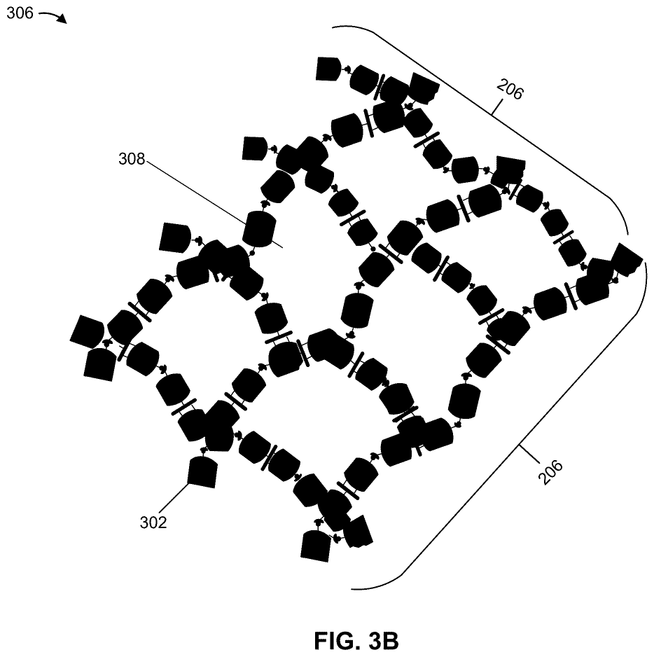

The receiving area 212 may include pipelines, electrical enclosures, and drilling equipment, among other examples. In the case of pipelines, a 3D printed object may be a cover used to protect pipelines that may need to be deformed in order to fit around the cylindrical shape of the pipeline, providing, for example, insulation, corrosion protection, and/or damage resistance. In the case of electrical enclosures, 3D printed objects may include protective covers for electrical equipment and/or control boxes, which can be deformed to fit around cylindrical and other curved components, ensuring a snug and protective fit, and offering resistance to environmental factors. In the case of drilling equipment, the 3D printed objects may include covers for drilling machinery, such as, for example, drilling machinery used in geotechnical and/or mining applications. The covers may be deformed to adapt their shape to cylindrical and other curved components, offering protection from dust, debris, and/or other harsh conditions. The snake robots 206 and 3D printed objects are described in more detail below in connection with FIGS. 3A-3B, 4A-4B, and 5A-5B.

The 3D printing management and design code 150 provides functionality to manage a 3D printing process and to design a structural arrangement of snake robots 206 on which a deformable portion of the 3D printed object can be applied. The 3D printing management and design code 150 provides a flexible and adaptable platform for 3D printing, enabling highly precise and accurate creation of deformable 3D printed objects that may be deformed over surfaces with complex and/or hard-to-reach geometries. The 3D printing management and design code 150 includes functionality to receive feedback and adjust the printing controls of snake robots 206 in real-time to ensure that the snake robots 206 deform 3D printed objects in areas that may be difficult to access and/or may be subject to continuously changing conditions (e.g., temperature and other environmental conditions) that may affect the ability of a 3D printed object to cover a given area.

In some aspects, the 3D printing management and design code 150 may simulate deformation of a 3D printed object using one or more digital models (e.g., digital twin models) of the 3D printed object. For example, the 3D printing management and design code 150 includes functionality to analyze various factors, such as the material properties, the shape, and the size of the 3D printed object, and the forces applied to the 3D printed object to deform the 3D printed object.

The 3D printing management and design code 150 may generate digital twin models to simulate the behavior of a 3D printed object in different scenarios. For example, the digital twin models may be created using data from various sources, such as sensors 208 and digital image data sources 210 (e.g., cameras). The digital twin models are used to predict different loads that may be applied to the 3D printed object to deform the 3D printed object.

The 3D printing management and design code 150 may have functionality for iteratively running a plurality of simulations of deformation of a deformable 3D printed object using a digital twin model, and designing, based on the plurality of simulations, a mesh-like structure of a plurality of robots (e.g., snake robots 206) over which the deformable 3D printed object is to be printed. In some implementations, the plurality of simulations compute one or more loads on the deformable 3D printed object to cause the deformation, where designing the mesh-like structure comprises defining a shape and dimensions of the mesh-like structure to exert the one or more loads on the deformable 3D printed object. Designing the mesh-like structure may include identifying a plurality of locations on the deformable 3D printed object where the plurality of robots will exert the one or more loads. The 3D printing management and design code 150 may be configured to cause a computing device to analyze specifications of the plurality of robots that cause the plurality of robots to operate collectively to exert the one or more loads.

In some implementations, the 3D printing management and design code 150 includes functionality to perform force simulations to determine the quantity (e.g., integer value) and positioning of snake robots needed to deform a 3D printed object. For example, 3D printing management and design code 150 is designed to enable a computing device (e.g., computer 102) to compute a self-weight of the 3D printed object. As used herein, “self-weight” refers to a load on a 3D printed object imposed by its own weight, and may be based at least in part on the material density of the 3D printed object.

The 3D printing management and design code 150 may be configured to cause a computing device to iteratively perform a plurality of force simulations of the 3D printed object based at least in part on the self-weight to determine the quantity and the positioning of a plurality of snake robots 206 to enable the plurality of snake robots 206 to deform a portion of the 3D printed object over a designated area (e.g., receiving area 212). In determining the quantity and position of the plurality of snake robots 206, the 3D printing management and design code 150 may be designed to cause analyzing of the programming of the snake robots 206 to permit them to operate as a unit. For example, the analysis takes into account specific tasks that the snake robots 206 need to collectively perform, such as deforming a 3D printed object, and the forces required to perform this task.

The 3D printing management and design code 150 may include functions for identifying, based at least in part on the 3D oriented object deformation simulations, a first portion of the 3D printed object that will remain static and a second portion of the 3D printed object that will deform. The 3D printing management and design code 150 may further include functions for analyzing specifications of a plurality of snake robots 206 on which the 3D printed object will be created, and determining a structural arrangement of the plurality of snake robots 206 to enable the plurality of snake robots to deform the second portion of the 3D printed object, where the structural arrangement includes the quantity (e.g., integer number) and positioning of the plurality of snake robots 206 with respect to each other.

In some implementations, the 3D printing management and design code 150 may include functionality to predict a designated area over which the second portion of a 3D printed object is to be deformed. For example, the prediction may be based on various characteristics of the receiving area 212 such as, for example, areas where safety is critical and areas where risks may exist. For example, in the case of electrical maintenance, the 3D printing management and design code 150 may be configured to cause a computing device to identify components that need to be protected and areas that should be isolated.

Additionally, or alternatively, the 3D printing management and design code 150 may include functionality to select a first material for the first portion (e.g., static (non-deformed) portion) of the 3D printed object, and to select a second material for the second portion (e.g., deformed portion) of the 3D printed object. The selecting of the first material and the selecting of the second material may be based at least in part on a training dataset including data selected from the group consisting of material flexibility, material durability, and material thermal resistance.

In some implementations, the 3D printing management and design code 150 may include functionality to cause a computing device to iteratively perform a plurality of force simulations of the 3D printed object to determine one or more forces on the first portion of the 3D printed object and/or the second portion of the 3D printed object, where the selecting of the first material and the selecting of the second material are based at least in part on the plurality of force simulations. A machine learning model may be used to select the type and thickness of 3D printing material for the first and/or second portions based on, for example, the forces applied to each portion to cause the deformation of the object over one or more locations of the receiving area 212. The machine learning model may be trained with historical data specifying one or more material properties (e.g., elasticity, flexibility, durability, heat resistance, and/or cold resistance) to select the type and the thickness of the 3D printing material.

In some implementations, inputs 214 including, for example, data specifying dimensions and/or a location of the first portion of the 3D printed object that is to remain static and data specifying dimensions and/or a location the second portion of the 3D printed object that is to be deformed, are transmitted from the computer 102 to the 3D printing environment 202. More particularly, the data specifying the first portion of the 3D printed object and the second portion of the 3D printed object may be transmitted to the 3D printing device 204 and/or the snake robots 206.

In some implementations, inputs 214 including, for example, data specifying a first material to be used for the first portion and a second material to be used for the second portion, are transmitted from the computer 102 to the 3D printing environment 202. More particularly, the data specifying the first and second materials may be transmitted to the 3D printing device 204 and/or the snake robots 206. In some implementations, the 3D printing materials include acrylonitrile butadiene styrene (ABS), polyactic acid (PLA), polyethylene terephthalate glycol (PETG), nylon, thermoplastic polyurethane (TPU), polyvinyl alcohol (PVA), high impact polystyrene (HIPS), carbon fiber, Kevlar, fiberglass, polypropylene, and/or resins, among other materials.

In some implementations, inputs 214 including, for example, data specifying the structural arrangement of a plurality of snake robots 206, are transmitted from the computer 102 to the 3D printing environment 202. More particularly, the data specifying the first and second materials may be transmitted to the 3D printing device 204 and/or the snake robots 206. The data specifying the structural arrangement of the plurality of snake robots may include, for example, data specifying the shape and the dimensions (e.g., length, width, height, area, etc.) of a mesh-like structure of the plurality of snake robots 206. The 3D printing device 204 is configured to 3D print the first portion and the second portion of the 3D printed object using the first material and the second material, and to 3D print the second portion of the 3D printed object on the structural arrangement of the plurality of snake robots 206.

In some implementations, the inputs 214 may include control data to control the movement of the plurality of snake robots 206, which supply forces to the 3D printed object to cause the deformation of the 3D printed object. The control data may be transmitted from the computer 102 to the snake robots 206.

In some implementations, feedback 216 including, for example, digital image data of the receiving area 212 from one or more digital image data sources 210, is transmitted from the 3D printing environment 202 to the computer 102. More particularly, the digital image data may be transmitted to the computer 102 from the digital image data sources 210, the snake robots 206, and/or the 3D printing device 204. The digital image data may include, for example, images and/or video from one or more cameras and/or Internet of Things (IoT) feeds in the 3D printing environment 202. The cameras and/or other digital image data sources 210 may be positioned at different portions of the receiving area 212, on the 3D printing device 204, and/or on the snake robots 206 to capture images and/or video of different portions of the 3D printing environment 202 that may be used by the 3D printing management and design code 150 to create and/or modify a digital twin model of the 3D printed object and/or cause and/or adjust deformation of the 3D printed object. The digital image data sources 210 may provide real-time data on the 3D printed object's environment and usage, allowing the system to adjust the deformation requirements accordingly.

In some implementations, feedback 216 including, for example, sensor data of the receiving area 212 from one or more sensors 208, is transmitted from the 3D printing environment 202 to the computer 102. More particularly, the sensor data may be transmitted to the computer 102 from the sensors 208, the snake robots 206, and/or the 3D printing device 204. The sensor data 208 from one or more sensors 208 in the 3D printing environment 202 may include, for example, temperature data, moisture data and/or other environmental conditions, force data (e.g., stress, strain, and/or load distribution data) on the 3D printed object and/or being exerted by the snake robots 206, speed and/or directional data of the snake robots 206, and/or data indicating amounts of deformation of the 3D printed object. The sensors 208 may be positioned at different portions of the receiving area 212, on the 3D printing device 204, and/or on the snake robots 206 to capture the sensor data from different portions of the 3D printing environment 202 that may be used by the 3D printing management and design code 150 to create and/or modify a digital twin model of the 3D printed object and/or cause and/or adjust deformation of the 3D printed object. The 3D printing management and design code 150 may include functionality to iteratively perform simulations with adjusted patterns of deformation (e.g., contour profiles) until safety and/or other conditions are met. Such conditions may include, for example, preventing and/or isolating the spray of water, oil, and/or other liquids, creating isolation areas, and/or creating safe zones. In the case of electrical maintenance, 3D printing management and design code 150 may include functionality to identify components that need to be protected and areas that should be isolated. For example, the 3D printing management and design code 150 may implement machine learning algorithms to iteratively design and test different contour profiles until the desired safety and risk isolation are achieved.

The computer 102 receives feedback 216 from various sources, including, for example, the snake robots 206, which may be equipped with the sensors 208, and/or digital image data sources 210 that detect the current state of 3D printed object and/or other portions of the 3D printing environment 202. The feedback 216 may be received during a printing process by the 3D printing device 204, and may be used to adjust printing parameters in real-time. For example, the 3D printing device 204 and/or the snake robots 206 may be controlled remotely using the computer 102, allowing for precise control over the printing process.

In some aspects, the 3D printing management and design code 150 may include functionality to use historical data to learn required levels of surface deformation for a specific activity context. For example, the computer 102 may use machine learning algorithms to analyze historical data and identify patterns and trends that inform the deformation requirements for a given activity context.

Additionally, or alternatively, the 3D printing management and design code 150 may include mechanisms to provide inputs 214 to the 3D printing environment to control addition (e.g., attachment) and subtraction (e.g., detachment) of snake robots 206 to and from the structural arrangement of snake robots 206. For example, the snake robots 206 may mechanically and/or magnetically attach to each other and/or to the 3D printed object.

Overall, the example implementation 200 illustrates a powerful system for 3D printing, offering a high degree of flexibility, precision, and customization. The ability to receive feedback and adjust the printing parameters in real-time provides an ideal platform for a wide range of applications, from rapid prototyping to production-scale manufacturing in a variety of harsh and/or difficult-to-access environments.

FIG. 2 is provided as an example. Other examples may differ from what is described with regard to FIG. 2.

FIG. 3A illustrates an example implementation 300 of a plurality of snake robots 206 that may be used in a structural arrangement on which a portion of a 3D printed object is formed. Each snake robot 206 includes a plurality of segments. The snake robots 206 are a type of robotic system designed to mimic the movement and flexibility of a snake. The snake robots 206 may be long, slender, and composed of multiple segments 302 that can bend and twist, allowing the snake robots 206 to navigate through tight spaces and adapt to changing environments.

The snake robots 206 may fit into small spaces and navigate through rubble or other surfaces which may be difficult to navigate. The snake robots 206 may be applied in, for example, pipelines and ductwork, that are difficult for humans to access. The snake robots 206 may include articulated joints, where each segment 302 of the snake robot 206 is connected by a joint 304 that can bend and twist, allowing for smooth and flexible movement. The snake robots 206 may be equipped with sensors 208 and/or digital image data sources 210 that allow the snake robots 206 to collect data in their environment.

The snake robots 206 may utilize various actuation systems, such as motors and/or pneumatic systems, to control the movement of each segment 302.

FIG. 3B illustrates an example implementation 306 of a plurality of snake robots 206 in a structural arrangement 308 on which a portion of a 3D printed object is formed. As shown in FIG. 3B, the structural arrangement 308 includes multiple snake robots 206 (e.g., multiple strands or “snakes”) arranged in different directions and crossing over and/or under each other in a mesh-like arrangement.

The structural arrangement 308 of the snake robots 206 is used to deform a 3D printed object by applying controlled forces to the object in order to shape and/or mold the object into a desired form. The 3D printing management and design code 150 includes functionality to determine the quantity (e.g., an integer number) and positioning of the snake robots 206 in the structural arrangement 308 to determine an optimal arrangement for achieving the desired deformation. In some cases, the 3D printing management and design code 150 may include functionality to determine a number of segments 302 and the type of joints 304 in each snake robot 206. The positioning of the snake robots 206 may include, for example, spacing and/or angles between snake robots that are adjacent to each other in the structural arrangement 308.

As noted herein, the structural arrangement 308 may be a mesh-like structure. As used herein, “mesh-like structure” refers to a network of interconnected snake robots 206 that work together to apply forces to a 3D printed object, causing the object to deform and take on a desired shape. The mesh-like structure may be a complex arrangement of multiple snake robots 206 that are connected and intertwined to form a web-like pattern. The mesh-like structure is designed to provide a high degree of flexibility and adaptability, allowing it to conform to complex shapes and surfaces.

In some implementations, the structural arrangement may be a three-dimensional grid, with each snake robot 206 representing a strand or a thread in the grid. The snake robots 206 can be spaced at varying distances apart, and can be connected to each other at different angles and orientations, to create an adaptable network. The structural arrangement 308 is capable of applying forces to the 3D printed object in multiple directions and at multiple points, allowing for precise control over the deformation process. The structure can be designed to apply uniform and/or non-uniform forces, depending on the desired shape and surface characteristics of the final product.

Advantageously, the snake robots 206 provide increased flexibility and adaptability since the snake robots 206 can be easily reconfigured based on feedback 216 to achieve different shapes and surfaces. Using, for example, inputs 214 that include control data to control movement of the snake robots 206, the snake robots 206 allow for precise control over the deformation process of a 3D printed object, enabling the creation of complex shapes and/or surfaces with high accuracy. The structural arrangement of the snake robots 206 also provides for the ability to deform 3D printed objects in a controlled manner, which can reduce the amount of material waste to 3D print an object that needs to be deformed.

FIGS. 3A and 3B are provided as examples. Other examples may differ from what is described with regard to FIGS. 3A and 3B.

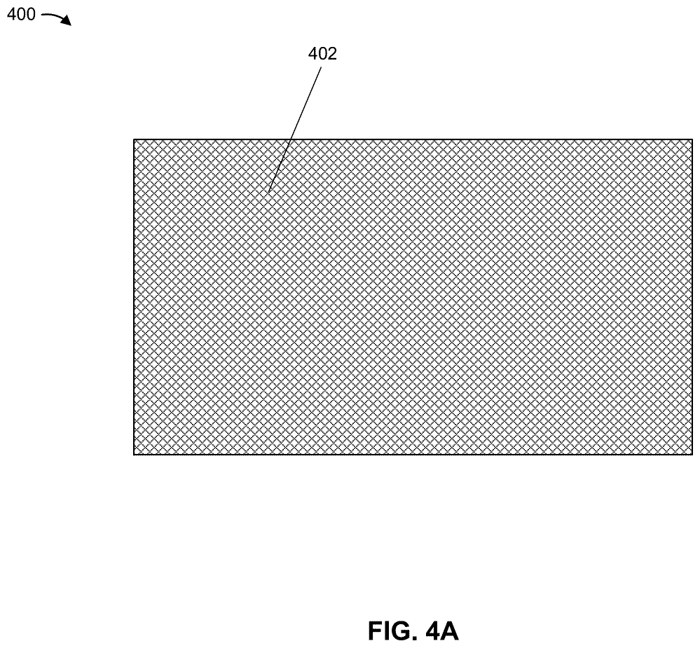

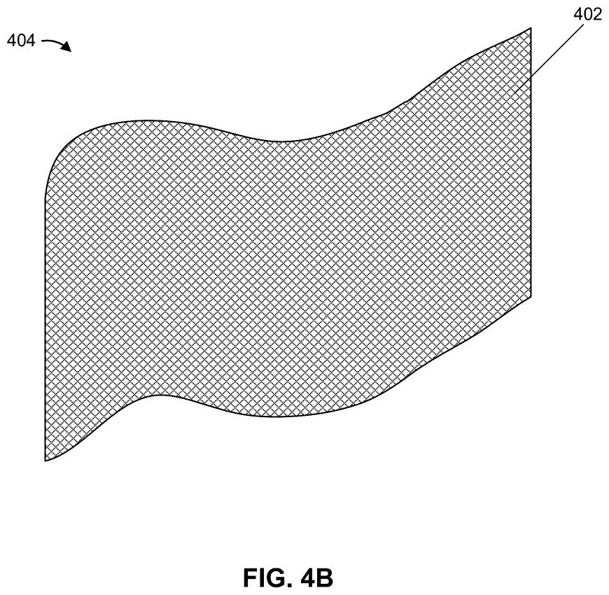

FIGS. 4A and 4B illustrate example implementations 400 and 404 of a 3D printed object 402 in a non-deformed state and a deformed state. In the example implementation 400, the 3D printed object 402 is in a non-deformed state and in the example implementation 404, the 3D printed object 402 is in a deformed state. As noted herein, the 3D printed object 402 may be printed on a structural arrangement of snake robots 206, which may be on an underside (not shown) of the 3D printed object 402. The structural arrangement may be capable of applying forces to the 3D printed object 402 in multiple directions and at multiple points, allowing for precise control over the deformation process to stretch, curve, and/or bend the 3D printed object 402 into the deformed state shown in the example implementation 404. The deformed state shown in the example implementation 404 is a non-limiting example, and other deformed states in other shapes (e.g., circular, oval, etc.) with curved sides and/or surfaces and/or a combination of curved and straight sides and/or surfaces may be formed using different structural arrangements of snake robots 206.

In some implementations, thermoplastic polyurethane (TPU), thermoplastic elastomer (TPE), acrylonitrile butadiene styrene (ABS), polyethylene terephthalate glycol (PETG), nylon, and/or resins, among other examples, are flexible and elastic materials that may be used as materials for a 3D printed object 402. The 3D printing material used may depend on the specific requirements of the object being created, including the desired level of deformation, the need for flexibility and elasticity, and the intended use of the object. The material selection may be based on a training dataset that includes data on material properties, such as flexibility, durability, and thermal resistance, among other examples.

FIGS. 4A and 4B are provided as examples. Other examples may differ from what is described with regard to FIGS. 4A and 4B.

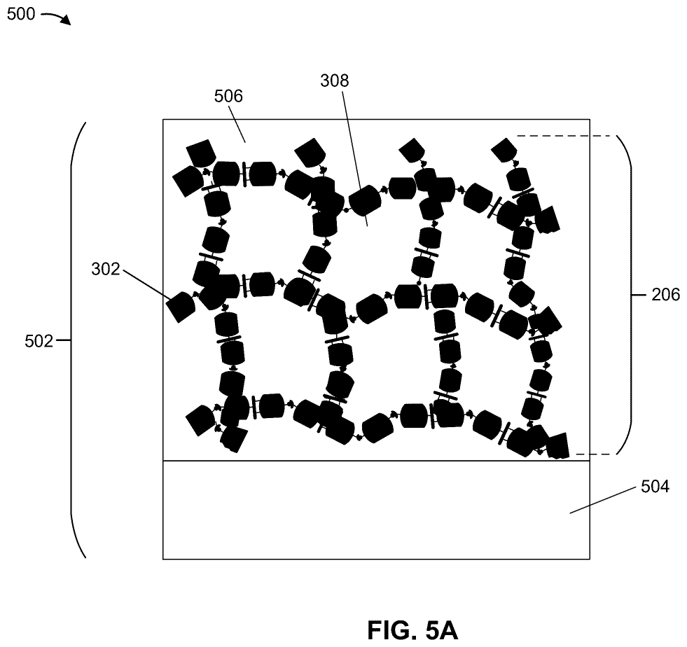

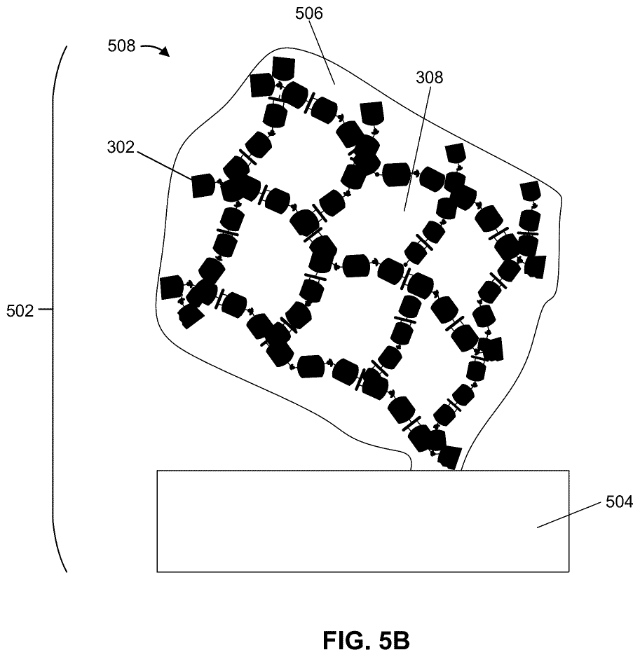

FIGS. 5A and 5B illustrate example implementations 500 and 508 of a 3D printed object 502 with a portion of the 3D printed object in a non-deformed state and a portion of the 3D printed object in a deformed state. In the example implementation 500, depicted in FIG. 5A, a first portion 504 of the 3D printed object 502 and a second portion 506 of the 3D printed object 502 are in a non-deformed state. The second portion 506 of the 3D printed object 502 is printed on the structural arrangement 308 of snake robots 206, which, as shown by the semi-transparent illustration of the first and second portions 504 and 506, is on an underside of the second portion 506 of the 3D printed object 502. In the example implementation 508, depicted in FIG. 5B, the second portion 506 of the 3D printed object 502 is in a deformed state, while the first portion 504 remains static (e.g., in the non-deformed state). The structural arrangement 308 may be capable of applying forces to the second portion 506 of the 3D printed object 502 in multiple directions and at multiple points, allowing for precise control over the deformation process to stretch, curve, and/or bend the second portion 506 of the 3D printed object 502 into the deformed state shown in the example implementation 508. The deformed state shown in the example implementation 508 is a non-limiting example, and other deformed states in other shapes (e.g., circular, oval, etc.) with curved sides and/or surfaces and/or a combination of curved and straight sides and/or surfaces may be formed using different structural arrangements of snake robots 206.

Similar to the 3D printed object 402, in some implementations, thermoplastic polyurethane (TPU), thermoplastic elastomer (TPE), acrylonitrile butadiene styrene (ABS), polyethylene terephthalate glycol (PETG), nylon, and/or resins, among other examples, are flexible and elastic materials that may be used as materials for the second portion 506 of the 3D printed object 502. A different material may be used for the first portion 504 of the 3D printed object, which remains static. For example, the material of the first portion 504 may be less flexible and/or elastic than the material of the second portion 506 of the 3D printed object 502. The 3D printing material used may depend on the specific requirements of the object being created, including the desired level of deformation, the need for flexibility and elasticity, and the intended use of the object. The material selection may be based on a training dataset that includes data on material properties, such as flexibility, durability, and thermal resistance, among other examples.

FIGS. 5A and 5B are provided as examples. Other examples may differ from what is described with regard to FIGS. 5A and 5B.

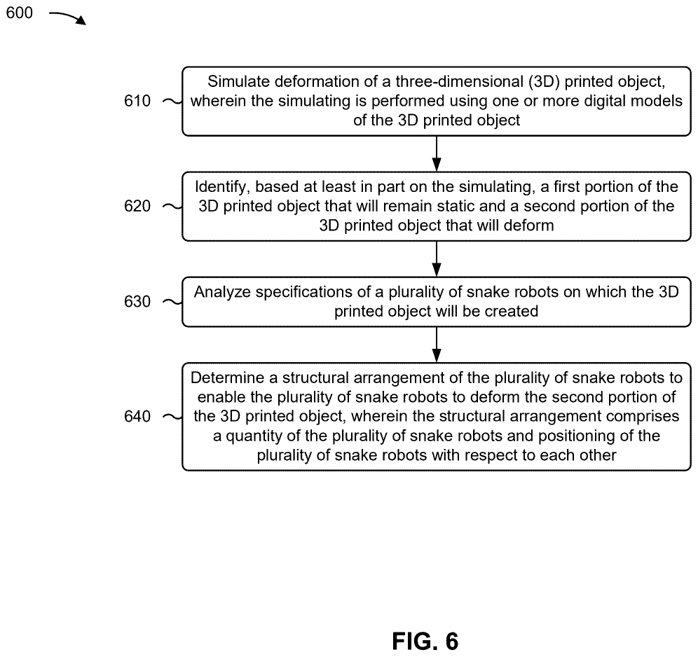

FIG. 6 is a flowchart of an example process 600 associated with the design and management of 3D printing operations. One or more process blocks of FIG. 6 are performed by a computer (e.g., computer 102 including 3D printing management and design code 150) and/or by another device or a group of devices separate from or including the computer, such as a 3D printing device (e.g., 3D printing device 204), snake robots (e.g., snake robots 206), sensors (e.g., sensors 208) and/or digital image data sources (e.g., digital image data sources 210). Additionally, or alternatively, one or more process blocks of FIG. 6 may be performed by one or more components of the computer 102, such as the processor set 114, communication fabric 116, volatile memory 118, persistent storage 120, operating system 130, peripheral device set 122, and/or network module 124.

As shown in FIG. 6, process 600 includes simulating deformation of a 3D printed object, wherein the simulating is performed using one or more digital models of the 3D printed object (block 610). For example, the computer may simulate deformation of a 3D printed object, wherein the simulating is performed using one or more digital models of the 3D printed object, as described above.

As further shown in FIG. 6, process 600 includes identifying, based at least in part on the simulating, a first portion of the 3D printed object that will remain static and a second portion of the 3D printed object that will deform (block 620). For example, the computer may identify, based at least in part on the simulating, a first portion of the 3D printed object that will remain static and a second portion of the 3D printed object that will deform, as described above.

As further shown in FIG. 6, process 600 includes analyzing specifications of a plurality of snake robots on which the 3D printed object will be created (block 630). For example, the computer may analyze specifications of a plurality of snake robots on which the 3D printed object will be created, as described above.

As further shown in FIG. 6, process 600 includes determining a structural arrangement of the plurality of snake robots to enable the plurality of snake robots to deform the second portion of the 3D printed object, wherein the structural arrangement comprises a quantity of the plurality of snake robots and positioning of the plurality of snake robots with respect to each other (block 640). For example, the computer may determine a structural arrangement of the plurality of snake robots to enable the plurality of snake robots to deform the second portion of the 3D printed object, wherein the structural arrangement comprises a quantity of the plurality of snake robots and positioning of the plurality of snake robots with respect to each other, as described above.

Process 600 may include additional aspects, such as any single aspect or any combination of aspects described below and/or in connection with one or more other processes described elsewhere herein.

In a first aspect, the simulating comprises generating the one or more digital models of the 3D printed object, wherein the one or more digital models comprise one or more digital twin models of the 3D printed object.

In a second aspect, alone or in combination with the first aspect, determining the structural arrangement of the plurality of snake robots comprises computing a self-weight of the 3D printed object, and iteratively performing a plurality of force simulations of the 3D printed object based at least in part on the self-weight to determine the quantity and the positioning of the plurality of snake robots to enable the plurality of snake robots to deform the second portion of the 3D printed object over a designated area.

In a third aspect, alone or in combination with one or more of the first and second aspects, determining the structural arrangement of the plurality of snake robots further comprises analyzing programming of the plurality of snake robots, permitting the plurality of snake robots to operate as a unit to generate one or more forces to deform the second portion of the 3D printed object over the designated area.

In a fourth aspect, alone or in combination with one or more of the first through third aspects, process 600 includes predicting the designated area over which the second portion of the 3D printed object is to be deformed, wherein the predicting is performed based at least in part on a training dataset comprising deformation of a plurality of materials over a plurality of objects.

In a fifth aspect, alone or in combination with one or more of the first through fourth aspects, process 600 includes selecting a first material for the first portion of the 3D printed object, and selecting a second material for the second portion of the 3D printed object that will deform, wherein the selecting of the first material and the selecting of the second material are based at least in part on a training dataset comprising data selected from the group consisting of material flexibility, material durability, and material thermal resistance.

In a sixth aspect, alone or in combination with one or more of the first through fifth aspects, process 600 includes iteratively performing a plurality of force simulations of the 3D printed object to determine one or more forces on at least one of the first portion of the 3D printed object or the second portion of the 3D printed object, wherein the selecting of the first material and the selecting of the second material are based at least in part on the plurality of force simulations.

In a seventh aspect, alone or in combination with one or more of the first through sixth aspects, process 600 includes inputting, to a 3D printing device, data specifying the first portion of the 3D printed object and data specifying the second portion of the 3D printed object, inputting, to the 3D printing device, data specifying the first material and the second material, and inputting, to the 3D printing device, data specifying the structural arrangement of the plurality of snake robots, wherein the 3D printing device is configured to 3D print the first portion and the second portion of the 3D printed object using the first material and the second material, and wherein the 3D printing device is configured to 3D print the second portion of the 3D printed object on the structural arrangement of the plurality of snake robots.

In an eighth aspect, alone or in combination with one or more of the first through seventh aspects, process 600 includes collecting digital image data from one or more digital image data sources of an area over which the second portion of the 3D printed object is to be deformed, and using the digital image data to generate the one or more digital models of the 3D printed object.

In a ninth aspect, alone or in combination with one or more of the first through eighth aspects, the plurality of snake robots are equipped with one or more sensors to detect a state of an area over which the second portion of the 3D printed object is to be deformed, and process 600 includes collecting sensor data from the one or more sensors, and using the sensor data to generate the one or more digital models of the 3D printed object.

In a tenth aspect, alone or in combination with one or more of the first through ninth aspects, process 600 includes iteratively performing the simulating with adjusted patterns of the deformation of the 3D printed object until one or more safety conditions are met.

Although FIG. 6 shows example blocks of process 600, in some implementations, process 600 includes additional blocks, fewer blocks, different blocks, or differently arranged blocks than those depicted in FIG. 6. Additionally, or alternatively, two or more of the blocks of process 600 may be performed in parallel.

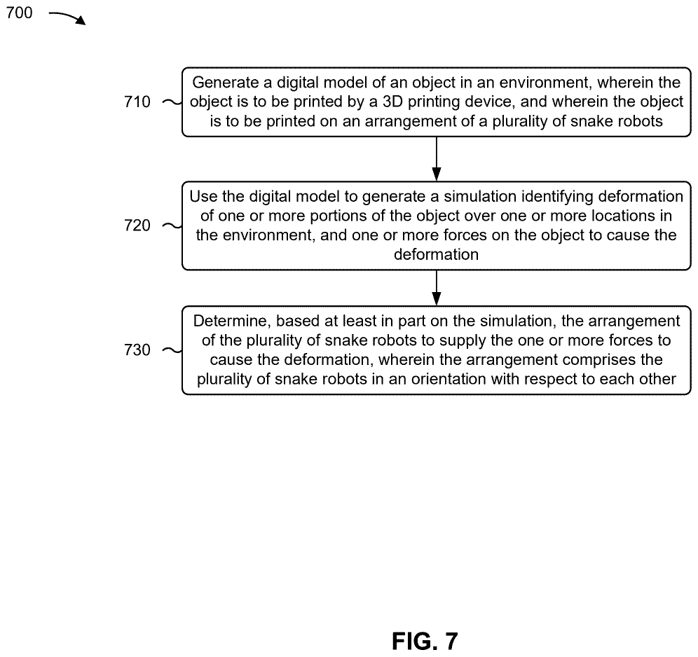

FIG. 7 is a flowchart of an example process 700 associated with the design and management of 3D printing operations. One or more process blocks of FIG. 7 are performed by a computer system (e.g., computer 102 including 3D printing management and design code 150) and/or by another device or a group of devices separate from or including the computer system, such as a 3D printing device (e.g., 3D printing device 204), snake robots (e.g., snake robots 206), sensors (e.g., sensors 208) and/or digital image data sources (e.g., digital image data sources 210). Additionally, or alternatively, one or more process blocks of FIG. 7 may be performed by one or more components of the computer 102, such as the processor set 114, communication fabric 116, volatile memory 118, persistent storage 120, operating system 130, peripheral device set 122, and/or network module 124.

As shown in FIG. 7, process 700 includes generating a digital model of an object in an environment, wherein the object is to be printed by a 3D printing device, and wherein the object is to be printed on an arrangement of a plurality of snake robots (block 710). For example, the computer system may generate a digital model of an object in an environment, wherein the object is to be printed by a 3D printing device, and wherein the object is to be printed on an arrangement of a plurality of snake robots, as described above.

As further shown in FIG. 7, process 700 includes using the digital model to generate a simulation identifying deformation of one or more portions of the object over one or more locations in the environment, and one or more forces on the object to cause the deformation (block 720). For example, the computer system may use the digital model to generate a simulation identifying deformation of one or more portions of the object over one or more locations in the environment, and one or more forces on the object to cause the deformation, as described above.

As further shown in FIG. 7, process 700 includes determining, based at least in part on the simulation, the arrangement of the plurality of snake robots to supply the one or more forces to cause the deformation, wherein the arrangement comprises the plurality of snake robots in an orientation with respect to each other (block 730). For example, the computer system may determine, based at least in part on the simulation, the arrangement of the plurality of snake robots to supply the one or more forces to cause the deformation, wherein the arrangement comprises the plurality of snake robots in an orientation with respect to each other, as described above.

Process 700 may include additional aspects, such as any single aspect or any combination of aspects described below and/or in connection with one or more other processes described elsewhere herein.

In a first aspect, the operations further comprise selecting a type and thickness of 3D printing material based at least in part on the one or more forces.

In a second aspect, alone or in combination with the first aspect, the operations further comprise using a machine learning model trained with historical data specifying one or more material properties to select the type and the thickness of the 3D printing material.

In a third aspect, alone or in combination with one or more of the first and second aspects, the operations further comprise controlling the plurality of snake robots to supply the one or more forces to cause the deformation.

In a fourth aspect, alone or in combination with one or more of the first through third aspects, the operations further comprise receiving feedback data about at least one of an amount of the deformation or one more environmental conditions affecting the deformation, and modifying the digital model based on the feedback data.

Although FIG. 7 shows example blocks of process 700, in some implementations, process 700 includes additional blocks, fewer blocks, different blocks, or differently arranged blocks than those depicted in FIG. 7. Additionally, or alternatively, two or more of the blocks of process 700 may be performed in parallel.

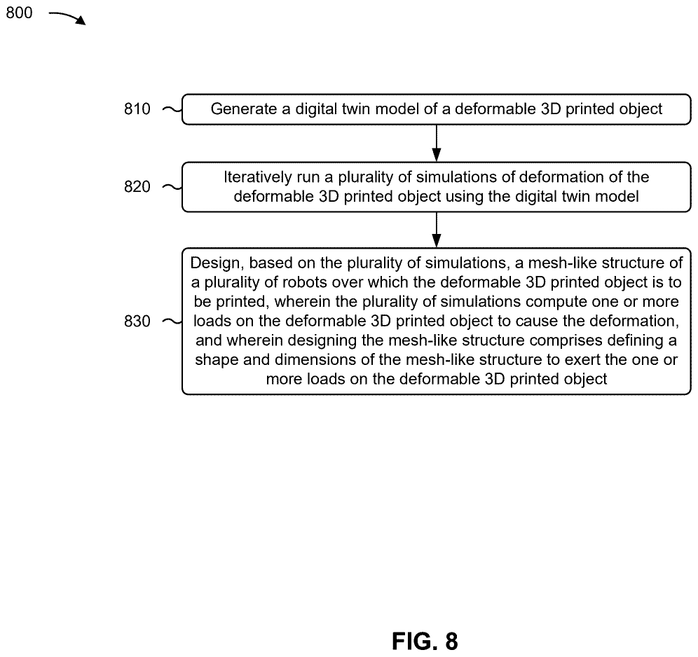

FIG. 8 is a flowchart of an example process 800 associated with the design and management of 3D printing operations. One or more process blocks of FIG. 8 are performed by a computer product (e.g., computer 102 including 3D printing management and design code 150) and/or by another device or a group of devices separate from or including the computer product, such as a 3D printing device (e.g., 3D printing device 204), snake robots (e.g., snake robots 206), sensors (e.g., sensors 208) and/or digital image data sources (e.g., digital image data sources 210). Additionally, or alternatively, one or more process blocks of FIG. 8 may be performed by one or more components of the computer 102, such as the processor set 114, communication fabric 116, volatile memory 118, persistent storage 120, operating system 130, peripheral device set 122, and/or network module 124.

As shown in FIG. 8, process 800 includes generating a digital twin model of a deformable 3D printed object (block 810). For example, the computer product may generate a digital twin model of a deformable 3D printed object, as described above.

As further shown in FIG. 8, process 800 includes iteratively running a plurality of simulations of deformation of the deformable 3D printed object using the digital twin model (block 820). For example, the computer product may iteratively run a plurality of simulations of deformation of the deformable 3D printed object using the digital twin model, as described above.

As further shown in FIG. 8, process 800 includes designing, based on the plurality of simulations, a mesh-like structure of a plurality of robots over which the deformable 3D printed object is to be printed, wherein the plurality of simulations compute one or more loads on the deformable 3D printed object to cause the deformation, and wherein designing the mesh-like structure comprises defining a shape and dimensions of the mesh-like structure to exert the one or more loads on the deformable 3D printed object (block 830). For example, the computer product may design, based on the plurality of simulations, a mesh-like structure of a plurality of robots over which the deformable 3D printed object is to be printed, wherein the plurality of simulations compute one or more loads on the deformable 3D printed object to cause the deformation, and wherein designing the mesh-like structure comprises defining a shape and dimensions of the mesh-like structure to exert the one or more loads on the deformable 3D printed object, as described above.

Process 800 may include additional aspects, such as any single aspect or any combination of aspects described below and/or in connection with one or more other processes described elsewhere herein.

In a first aspect, designing the mesh-like structure further comprises identifying a plurality of locations on the deformable 3D printed object where the plurality of robots exert the one or more loads.

In a second aspect, alone or in combination with the first aspect, designing the mesh-like structure further comprises analyzing specifications of the plurality of robots that cause the plurality of robots to operate collectively to exert the one or more loads.

In a third aspect, alone or in combination with one or more of the first and second aspects, the operations further comprise selecting a material to use for printing the deformable 3D printed object based at least in part on an amount of the deformation, inputting data specifying the material to a 3D printing device, and inputting data specifying the shape and the dimensions of the mesh-like structure to the 3D printing device, wherein the 3D printing device is configured to 3D print the deformable 3D printed object on the mesh-like structure.

Although FIG. 8 shows example blocks of process 800, in some implementations, process 800 includes additional blocks, fewer blocks, different blocks, or differently arranged blocks than those depicted in FIG. 8. Additionally, or alternatively, two or more of the blocks of process 800 may be performed in parallel.

The foregoing disclosure provides illustration and description, but is not intended to be exhaustive or to limit the implementations to the precise forms disclosed. Modifications may be made in light of the above disclosure or may be acquired from practice of the implementations. For example, various aspects of this disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

A computer program product embodiment (“CPP embodiment” or “CPP”) is a term used in this disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, RAM, ROM, erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc), or any suitable combination of the foregoing. A computer-readable storage medium, as that term is used in this disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code-it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method comprising:
simulating deformation of a three-dimensional (3D) printed object,
wherein the simulating is performed using one or more digital models of the 3D printed object;
identifying, based at least in part on the simulating, a first portion of the 3D printed object that will remain static and a second portion of the 3D printed object that will deform;
analyzing specifications of a plurality of snake robots on which the 3D printed object will be created; and
determining a structural arrangement of the plurality of snake robots to enable the plurality of snake robots to deform the second portion of the 3D printed object,
wherein the structural arrangement comprises a quantity of the plurality of snake robots and positioning of the plurality of snake robots with respect to each other.

2. The method of claim 1, wherein the simulating comprises:
generating the one or more digital models of the 3D printed object,
wherein the one or more digital models comprise one or more digital twin models of the 3D printed object.

3. The method of claim 1, wherein determining the structural arrangement of the plurality of snake robots comprises:
computing a self-weight of the 3D printed object; and
iteratively performing a plurality of force simulations of the 3D printed object based at least in part on the self-weight to determine the quantity and the positioning of the plurality of snake robots to enable the plurality of snake robots to deform the second portion of the 3D printed object over a designated area.

4. The method of claim 3, wherein determining the structural arrangement of the plurality of snake robots further comprises analyzing programming of the plurality of snake robots, permitting the plurality of snake robots to operate as a unit to generate one or more forces to deform the second portion of the 3D printed object over the designated area.

5. The method of claim 3, further comprising predicting the designated area over which the second portion of the 3D printed object is to be deformed,
wherein the predicting is performed based at least in part on a training dataset comprising deformation of a plurality of materials over a plurality of objects.

6. The method of claim 1, further comprising:
selecting a first material for the first portion of the 3D printed object; and
selecting a second material for the second portion of the 3D printed object that will deform,
wherein the selecting of the first material and the selecting of the second material are based at least in part on a training dataset comprising data selected from the group consisting of material flexibility, material durability, and material thermal resistance.

7. The method of claim 6, further comprising:
iteratively performing a plurality of force simulations of the 3D printed object to determine one or more forces on at least one of the first portion of the 3D printed object or the second portion of the 3D printed object,
wherein the selecting of the first material and the selecting of the second material are based at least in part on the plurality of force simulations.

8. The method of claim 6, further comprising:
inputting, to a 3D printing device, data specifying the first portion of the 3D printed object and data specifying the second portion of the 3D printed object;
inputting, to the 3D printing device, data specifying the first material and the second material; and
inputting, to the 3D printing device, data specifying the structural arrangement of the plurality of snake robots,
wherein the 3D printing device is configured to 3D print the first portion and the second portion of the 3D printed object using the first material and the second material, and
wherein the 3D printing device is configured to 3D print the second portion of the 3D printed object on the structural arrangement of the plurality of snake robots.

9. The method of claim 1, further comprising:
collecting digital image data from one or more digital image data sources of an area over which the second portion of the 3D printed object is to be deformed; and
using the digital image data to generate the one or more digital models of the 3D printed object.

10. The method of claim 1, wherein the plurality of snake robots are equipped with one or more sensors to detect a state of an area over which the second portion of the 3D printed object is to be deformed, and
wherein the method further comprises:
collecting sensor data from the one or more sensors; and
using the sensor data to generate the one or more digital models of the 3D printed object.

11. The method of claim 1, further comprising:
iteratively performing the simulating with adjusted patterns of the deformation of the 3D printed object until one or more safety conditions are met.

12. A computer system comprising:
a processor set;
one or more computer-readable storage media; and
program instructions stored on the one or more computer-readable storage media to cause the processor set to perform operations comprising:
generating a digital model of an object in an environment,
wherein the object is to be printed by a three-dimensional (3D) printing device, and
wherein the object is to be printed on an arrangement of a plurality of snake robots;
using the digital model to generate a simulation identifying deformation of one or more portions of the object over one or more locations in the environment, and one or more forces on the object to cause the deformation; and
determining, based at least in part on the simulation, the arrangement of the plurality of snake robots to supply the one or more forces to cause the deformation,
wherein the arrangement comprises the plurality of snake robots in an orientation with respect to each other.

13. The computer system of claim 12, wherein the operations further comprise:
selecting a type and thickness of 3D printing material based at least in part on the one or more forces.

14. The computer system of claim 13, wherein the operations further comprise:
using a machine learning model trained with historical data specifying one or more material properties to select the type and the thickness of the 3D printing material.

15. The computer system of claim 12, wherein the operations further comprise:
controlling the plurality of snake robots to supply the one or more forces to cause the deformation.

16. The computer system of claim 12, wherein the operations further comprise:
receiving feedback data about at least one of an amount of the deformation or one more environmental conditions affecting the deformation; and
modifying the digital model based on the feedback data.

17. A computer product comprising:
one or more computer-readable storage media; and
program instructions stored on the one or more computer-readable storage media to perform operations comprising:
generating a digital twin model of a deformable three-dimensional (3D) printed object;
iteratively running a plurality of simulations of deformation of the deformable 3D printed object using the digital twin model; and
designing, based on the plurality of simulations, a mesh-like structure of a plurality of robots over which the deformable 3D printed object is to be printed,
wherein the plurality of simulations compute one or more loads on the deformable 3D printed object to cause the deformation, and
wherein designing the mesh-like structure comprises defining a shape and dimensions of the mesh-like structure to exert the one or more loads on the deformable 3D printed object.

18. The computer product of claim 17, wherein designing the mesh-like structure further comprises identifying a plurality of locations on the deformable 3D printed object where the plurality of robots exert the one or more loads.

19. The computer product of claim 17, wherein designing the mesh-like structure further comprises analyzing specifications of the plurality of robots that cause the plurality of robots to operate collectively to exert the one or more loads.

20. The computer product of claim 17, wherein the operations further comprise:
selecting a material to use for printing the deformable 3D printed object based at least in part on an amount of the deformation;
inputting data specifying the material to a 3D printing device; and
inputting data specifying the shape and the dimensions of the mesh-like structure to the 3D printing device,
wherein the 3D printing device is configured to 3D print the deformable 3D printed object on the mesh-like structure.
